(19) United States
(12) Patent Application Publication
(10) Pub. No.: US 2005/0217657 A1
(43) Pub. Date: Oct. 6, 2005

(54) AN ULTRA-LIGHT BACKPACKING STOVE AND INSULATED CUP

(76) Inventor: Robert Anue, Los Gatos, CA (US)

Correspondence Address: PATENTRY, 300 MURCHISON DRIVE, SUITE 218, MILLBRAE, CA, 94030, US

(21) Appl. No.: 10/708,995

(22) Filed: Apr. 6, 2004

(51) Int. Cl. A47J 33/00

(52) U.S. Cl. 126/9 R

(57) ABSTRACT

An ultra-light stove and cook pot that when packed up for storage convert to an insulated cup, comprising a cook pot, a windscreen, a stand and a tray for suspending a burning fuel tablet. Packed up for storage, the cook pot functions as a cup, the tray insulates the bottom of the cup, the windscreen insulates the sides of the cup, and the stand encircles and holds everything securely in place.

### BACKGROUND OF INVENTION

1. Field of the Invention

The invention relates generally to portable cooking apparatus and more particularly to lightweight compact stoves and cookware suitable for backpacking.

2. Related Art

Carrying a backpack is a convenient method to travel economically. For many people it is a preferred way to travel into the wilderness to experience the beauty of nature and for spiritual renewal. While traveling this way, it is usually desirable to be self-sufficient in food preparation. In some areas of unusual natural beauty, open fires, and use of natural vegetation as fuel is prohibited. Even if allowed, the time required for setting up camp and meal preparation limits the available time for travel. Portable stoves in such situations make desirable the attributes of easy setup and disassembly for storage. It is important that the fewest parts be deployed both for weight and to minimize the opportunity for misplacing a critical component during packing. It is desirable that food may be consumed as the campsite is being cleared and that the stove may be one of the last things to be packed.

Convenience, weight, resilience, and volume are important factors when traveling with a backpack. As our population ages gracefully, they retain much of their health and curiosity about the world, have more recreational time, but less physical strength and stamina. Camping provides an economical way for them to enjoy traveling but would be prohibitive if equipment required the ability to carry the 25-60 pound (25-30% of body weight) packs considered typical among wilderness adventurers.

Typically cookware is a burden of 8 ounces per person and a stove with fuel weighs 24 ounces unless exotic materials have been employed. In addition, filthy portions of the stove with residue of combustion and fuel are packed for storage either in contact with surfaces that will need to be clean for food heating or in contact with and contaminating other items in the backpack, or both.

### SUMMARY OF INVENTION

Accordingly, what is needed is an improved portable stove that provides both low weight and volume, less complexity and cleaning, and minimizes cookware.

A portable camp stove is described comprising a cook pot and a tray, a frame or stand, and a sleeve or windscreen all of which, with the addition of an elastic insulating band, is inclusively stored in the form of an insulated cup.

In the configuration for storage, the portable stove may be held in one hand and still contain hot liquids. The cook pot is first encircled by the tray and then by the sleeve which is fastened by the concentric force of the frame. Once the food has been consumed, the portable stove may be cleaned and stored without further assembly or rearrangement.

To configure the portable stove for cooking, the frame is slid off the sleeve and inverted onto the cooking surface. Then the sleeve is removed from around the cook pot and tray. The cook pot and tray are set upon the frame, and the tray is slid downward along the cook pot to be suspended from the frame, the top part of the tray remaining around the bottom of the cook pot and functioning to stabilize it on the frame. Finally the fuel is placed on the tray and ignited, and the sleeve can be wrapped around the frame to function as a windscreen and heat shield.

Thus, the stove may be deployed for cooking in well under 1 minute. It can also be quickly packed up to function as an insulated cup, even while containing a hot liquid that has just been brought to a boil.

In summary, the present invention is stored in the configuration of an insulated cup, said insulated cup having an inner container which serves as a cook pot and an outer skin which serves as a windscreen, an internal skeletal structure provided by a tray, and a fastening provided by a frame. The frame protects an ultra-light cook pot from deformation during storage and supports the pot during cooking. A tray holds fuel tablets or liquid and stabilizes the cook pot on the frame during cooking and protects and insulates the bottom of the pot during storage. A sleeve screens the tray from wind gusts and concentrates heat on the pot during cooking and, during storage, protects and insulates the sides of the pot. The frame fastens the sleeve around the tray and the cook pot for storage. The sleeve is rigidly held between the tray and the frame and helps protect the ultra-light cook pot from crushing in storage. The containment of air between the tray and the cook pot, and between the sleeve and the cook pot, insulates the consumer's hand from the heat of the cook pot and its contents. An elastic insulating band around the top of the pot allows hot liquids to be drunk from it as a cup.

### BRIEF DESCRIPTION OF DRAWINGS

FIG. 1. A cook pot

FIGS. 2a and 2b. Two views of a frame

FIG. 3. A tray

FIG. 4. A sleeve

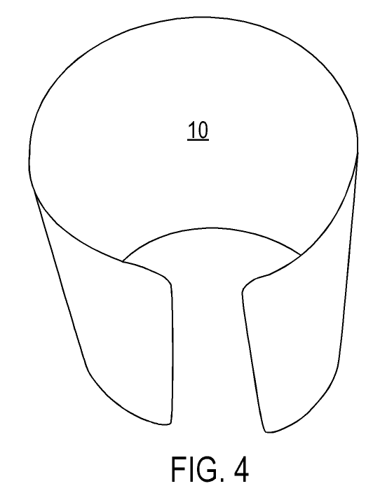

FIG. 5. The internal assembly of a cooking configuration of an ultra-light backpacking stove showing a cook pot, a tray, and a frame

FIG. 6. The external perspective view of a cooking configuration of an ultra-light backpacking stove showing a cook pot, a tray, a frame, and a sleeve.

FIG. 7. A middle perspective view of a storage configuration of an ultra-light backpacking stove showing a cook pot, a frame, a sleeve, and an elastic band.

FIG. 8. A bottom perspective view of a storage configuration of an ultra-light backpacking stove showing a cook pot, a frame, a tray, a sleeve, and an elastic band.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

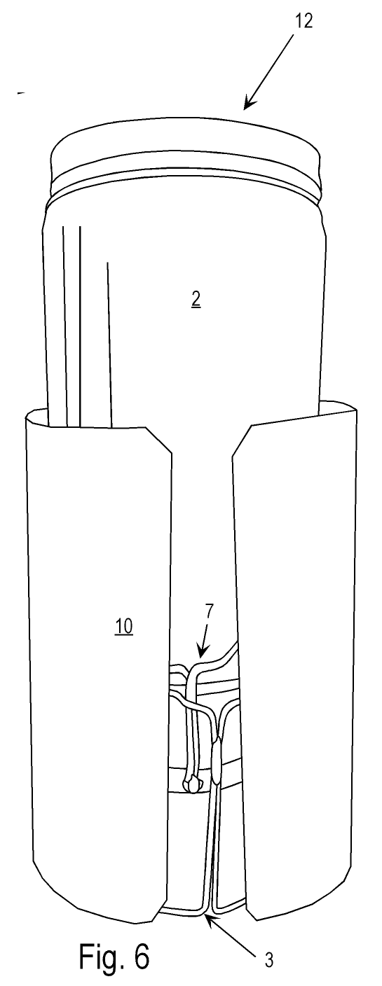

Referring now in detail to FIG. 6, there is shown a stove, generally designated by reference numeral 12 constructed in accordance with the teachings of the present invention. In the embodiment illustrated, the stove 12 comprises a cook pot 2 secured to a frame 3, heated by burning fuel on a tray 7, and protected from the wind by a sleeve 10.

The present invention comprises a cook pot 2, a frame 3, a tray 7, a sleeve 10 and a band 1 used in conjunction with solid or liquid fuel contained in packaging.

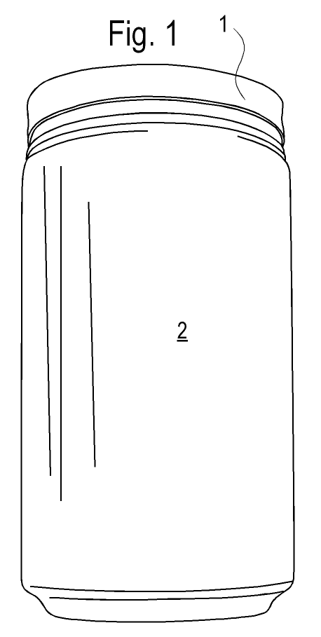

With regard to FIG. 1, the cook pot 2 is cylindrical, light weight, open at the top, closed on the bottom, and a circumference suitable to be held in one hand. A soft elastic band 1 may be placed over the upper lip to protect the user's mouth from heat or abrasion.

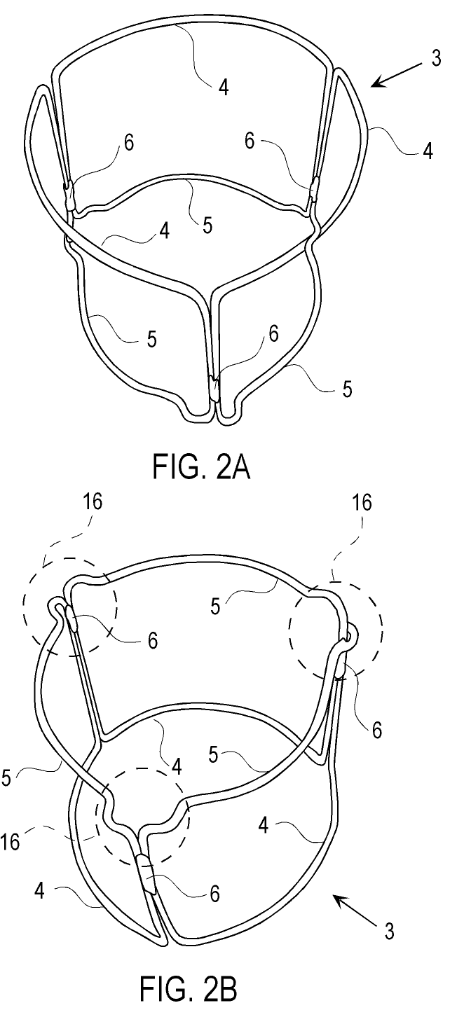

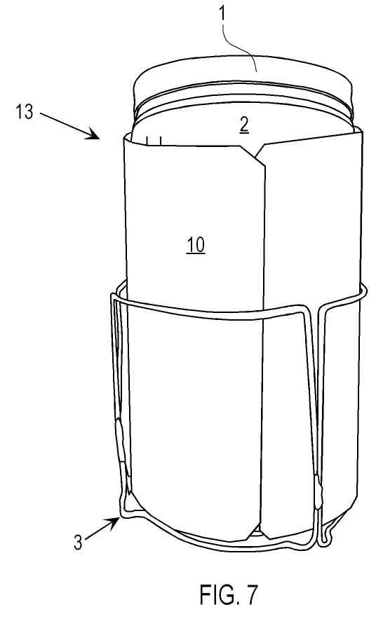

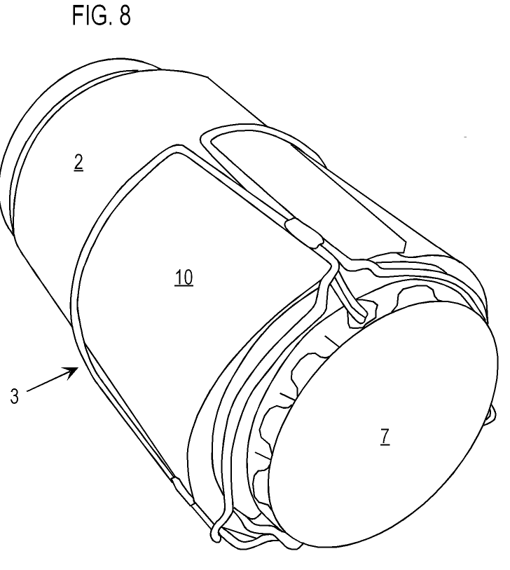

The frame 3 shown in FIGS. 2A and 2B also has a cylindrical form. One cylindrical end of the frame, which we will refer to as the Large End 4, presents an interior diameter large enough to allow the cook pot to easily pass through. The other end of the frame, which is referred to as the Small End 5, does not allow the cook pot to pass through either in cooking configuration or in storage configuration. In the cooking configuration the Small End 5 provides horizontal support means to the cook pot. In the storage configuration, the cook pot which is wrapped within the other elements, slides into the large end of the frame until it reaches the depth of the frame at which point it abuts the interior of the Small End 5 of the frame. In the storage configuration, the walls of the frame at the Large End 4 apply a slight concentric force upon all the other elements of the present invention which it encloses, and it functions as a fastener to hold everything together. The storage configuration shown in FIGS. 7 and 8 also functions as an insulated cup for consumption.

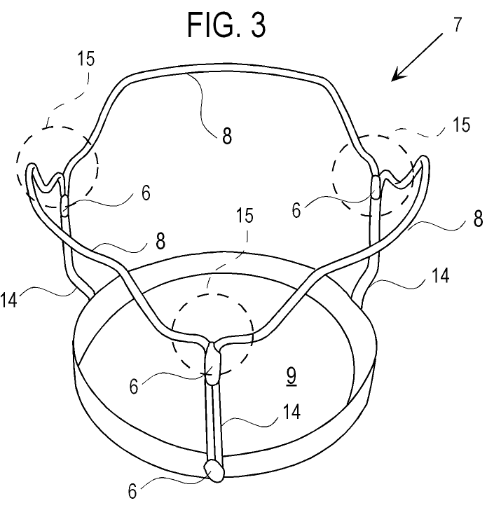

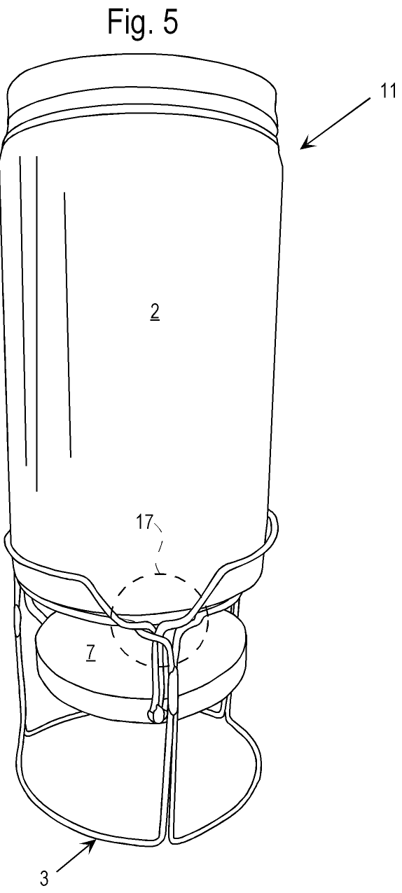

The tray 7 shown in FIG. 3 is also cylindrical and has an open top 8 and a closed bottom 9. The bottom 9 of the tray provides a platform for combustion of a fuel tablet or liquid fuel. The top 8 of the tray provides a concentric force that grips the cook pot in the cooking configuration, and provides stability when the cook pot is being heated by fuel ignited in the tray's platform 9. The top 8 of the tray has a circumference slightly larger than the cook pot. In cooking configuration shown in FIGS. 5 and 6 the cook pot 2 is partially slid into the tray 7 and held away from the fuel. In storage configuration shown in FIGS. 7 and 8, the tray 7 is slid up onto the bottom of the cook pot, and the inside of the bottom 9 of the tray rests securely against the bottom of the cook pot. The tray and cook pot never need to be completely separated; they are slid slightly apart for the cooking configuration, and slid together for the storage configuration.

During cooking, the tray 7 is suspended within the frame 3 by vertical suspension means 14 while the cook pot is horizontally supported above it upon the frame's small end 5. The dimension of the platform and lower portion of the tray is small enough to pass through the Small End 5 of the frame. The bearing means 17 comprises the Y joint 15 resting on the ears 16 of the frame 3 and prevents the tray 7 from passing entirely into the interior of the frame 3.

The sleeve 10 is made of a reflective, non-combustible, and resilient material that retains some shape memory after deformation. Rolled into a coiled cylinder, it retains flexibility radially but is much stiffer axially and will support itself standing on either end. Due to the shape memory induced by deformation, it will tend to curl up unless held open by some force.

The sleeve 10 is placed on the cooking surface exterior to the frame 3 to protect the combustion of the fuel placed on the platform 9 of the tray 7. Held slightly away from the sides of the cook pot by the larger circumference of the frame, it offers a slit for igniting the fuel and for air to pass for combustion. The sleeve reflects and concentrates heat to the bottom and sides of the cook pot. It prevents wind gusts from extinguishing the fuel until it is fully consumed.

The sleeve 10 cools quickly and may be raised by hand above the frame where it naturally curls tighter to wrap more closely to the cook pot. In the storage configuration shown in FIGS. 7 and 8, the vertical suspension means 14 create an air gap between the exterior of the cook pot 2 and the interior of the sleeve 10, which provides a thermal insulator. In the storage configuration, the sleeve 10 provides a thermal mitten to protect the consumer's hand from the potentially hot sides of the cook pot 2.

When the fuel has been extinguished, the platform 9 cools quicker than the heated food contained in the cook pot due to its lower thermal inertia and the tray 7 may be slid upward to enclose and abut to the bottom of the cook pot. In the storage configuration, the platform 9 of the tray 7 creates an airspace and thermal barrier to protect the consumer's hand from the bottom of the cook pot in contact with hot food.

The conversion from cooking configuration to storage configuration consists of three steps: A. Lifting the tray upward to abut the bottom of the cook pot, B. Raising the pot and tray from the frame by grasping them within the sleeve, and, C. Inverting the frame so that the Large End 4 is aligned toward the bottom of the cook pot and slightly twisting the sleeve into a cone shape which acts as a funnel to insert the cook pot, the tray and the sleeve down through the Large End 4 and into the frame. Twisting of the frame 3 along the sleeve 10 will align the vertical suspension means 14 of the tray to pass through the ears 16 of the small end 5. FIGS. 7 and 8 show the elements of the ultra light stove configured for storage which protects the sides and bottom of the cook pot from puncture or crushing. Food may be consumed and the cook pot cleaned in the storage configuration. Note that sooty surfaces of the cook pot 2 and the platform 9 are covering each other in the storage configuration so that the cook pot is clean to handle.

[Preferred Embodiment]

In the preferred embodiment of the present invention everything is designed to be light in weight. In one embodiment the cook pot is fabricated using exceptionally light and thin aluminum, which makes it prone to denting. Cook pots and cups can be handled with care when being used, but they are most vulnerable to being dented when they are being transported, such as in a backpack. Because of the added strength given to the pot in its storage configuration surrounded by the sleeve, tray, and frame, the pot can be constructed to be extraordinarily light weight yet survive being transported in a backpack. The dimensions of the cook pot are chosen for it to be taller than it is wide for thermal efficiency and weight minimization of frame and sleeve. In the preferred embodiment the pot is sized to be easily held in one hand, and to double as a cup eliminating the weight of additional cookware. The frame and sleeve are designed to pack around the cook pot, for compact and easy transport. In storage configuration, the sooty surfaces of tray and the cook pot cover each other. Using the best choice of materials today, the frame is composed of wire for light weight with no sharp wire ends for safety. The plurality of wire loops that form the legs serve three purposes. The loops make the frame a more stable stand. The continuous loops provide a crush resistant structure around the cook pot in the storage configuration. The loops make a spring action closing that helps hold the frame on the cook pot in the storage configuration. The non-fuel bearing side of the tray is also composed of wire wherein the upper loops of the tray are the vertical suspension means and grip the bottom of the cook pot for stability when the pot is standing on the frame in cooking configuration.

The ultra-light backpacking stove is comprised of multifunction parts, which will be referred to briefly as Pot, Sleeve, Frame, and Tray.

The Pot is a vessel used to contain food and is in contact with flame for cooking. It also is used for food service and will replace a cup in the camper's load. In the preferred embodiment the pot is made from a 750 ml beverage container such as an aluminum beer can with its top removed. A cook pot created in this fashion has many desirable attributes, including being readily obtainable, inexpensive, and extremely light weight. A potential problem with using a beverage container for a backpacking cook pot is its fragility, and the parts of the present invention are designed to address this weakness.

The Sleeve offers three advantages over camping stoves of previous design: In the storage configuration the Sleeve protects the cook pot. In the cooking configuration, it expands to provide a windscreen to protect the fuel from being extinguished by gusts, and it reflects heat to the sides of the cook pot. In storage configuration, it serves as a thermal mitten by providing an air gap between consumer's hand and the sides of the cook pot which may transmit the heat of the food.

The Tray has three advantages over camping stoves of previous design. In storage configuration it protects the bottom of the cook pot from puncture and its suspension members help prevent denting of the cook pot. In the cooking configuration, it suspends a burning fuel tablet or liquid off the ground and optimally centered below the cook pot. After the fuel is consumed, it cools quickly and when abutted to the cook pot serves as an insulating bottom, by providing an air gap between consumer's hand and the bottom of the cook pot.

The Frame has three advantages over previous stoves. In storage configuration it slides over the Sleeve and Tray to hold them securely to the cook pot. In cooking configuration it provides the vertical support for cook pot and the Tray. In cooking configuration the Frame also holds the Sleeve horizontally in an optimal spacing around the Tray and the Pot.

The Frame is composed of stiff non-combustible, corrosion resistant wire bent and fastened to a three dimensional cylindrical form. A plurality of large loops form the legs when the frame is used as the support for the cook pot during cooking. In the preferred embodiment the loops are not continuously curved and have flattened portions to provide stability when they are used as legs. The concentric compression of the loops serve as the fastener to secure the Sleeve, the Tray and the Pot during storage.

The Tray has a flat non-combustible metal surface to hold fuel during combustion, and a plurality of vertical suspension means embodied in wire loops. These vertical suspension means pass through the Frame in one direction during cooking and in the opposite direction during storage configuration. The vertical suspension means rest on the horizontal support means of the Frame embodied in a circular wire member with ears that extend beyond the circumference of the cook pot. The vertical suspension means extend through the ears and above the Frame to grasp the cook pot and provide stability to it.

In the preferred embodiment the wire loops are made of stainless steel and held in place by solder or welds 6. The addition of an insulating elastic band 1 improves its performance as an insulated cup by protecting the consumer's lips from the hot metal of the pot. However to those skilled in the art, substitution of material other than stainless steel, treated or untreated for corrosion resistance, for vertical suspension means is obvious but less optimal.

In contrast with camping stoves of previous design, sooty portions are not stored in contact with the internal surfaces that touch food nor the exterior surfaces that touch the other contents of the backpack. The setup and packing process is much quicker and may occur while the cup contains a liquid. The low number of separate parts make it lighter and reduces the chance of losing parts in dark or stormy weather. The weight is low because the stove protects a light cook pot from damage in storage. Cooking is quicker due to the windscreen and heat reflective effect of the sleeve.

The foregoing description of the preferred embodiment of the invention are to be considered in all respects as illustrative and not restrictive, the scope of the invention being indicated by the appended claims rather than by the foregoing description, and all changes that come within the meaning and range of equivalency of the claims therefore are intended to be embraced therein. The embodiment described is selected to best explain the principles of the invention and its practical application to thereby enable others skilled in the art to best utilize the invention in various embodiments and with modifications as suited to the particular purpose contemplated.

1. An apparatus comprising a tray, a sleeve, and a frame that functions with a cook pot in two configurations,
a first configuration being used for cooking in which the frame supports the tray and the cook pot, and the sleeve is positioned around the tray, the cook pot and the frame so that it functions as a windscreen and a heat reflector, and
a second configuration in which the frame is wrapped around the cook pot, the tray and the sleeve, holding the cook pot, the tray and the sleeve together for storage.

2. The apparatus of claim 1 having dimensions to function with a cook pot that is an empty beverage container.

3. The apparatus of claim 2 having dimensions to function with a cook pot that is an empty 750 ml aluminum beer can.

4. The sleeve of claim 1, wherein the sleeve is a self supporting flexible cylindrical wall having an expandable opening to provide access to the tray for air and ignition means in the first configuration.

5. The frame of claim 1 in which the frame comprises bent wire in a plurality of loops surrounding a central horizontal member smaller than the diameter of the cook pot with a plurality of protuberances that extend beyond the circumference of the cook pot.

6. The frame of claim 1 wherein the frame has a cylindrical wall and a horizontal support means at one end of the cylinder.

7. The frame of claim 6 wherein the cylindrical wall has an interior diameter larger than that of a cook pot allowing the lower portion of the cook pot to be enclosed within the frame.

8. The frame of claim 6 wherein the cylinder wall comprises a plurality of wire loops which apply a concentric force if spread apart.

9. The frame of claim 6 wherein the horizontal support means has an interior diameter smaller than that of a cook pot and wherein the horizontal support means has protuberances extending beyond the circumference of the cook pot through which a vertical suspension means of a tray may pass in one direction or another and on which the vertical suspension means of the tray may rest.

10. The tray of claim 1 in which the vertical wall of the fuel tray comprise a plurality of loops that grasp the cook pot and rest on the frame in the second configuration.

11. The tray of claim 1 wherein the tray comprises a platform and vertical suspension means, wherein said platform allows solid or liquid fuel to be ignited below the cook pot in the first configuration.

12. The tray of claim 11 wherein the vertical suspension means grasp the bottom of a cook pot with a concentric force in the first and second configurations.

13. The tray of claim 12 wherein the vertical suspension means may slide upwards along the side of a cook pot to abut the platform to the bottom of the cook pot.

14. An apparatus comprising an insulating band, a tray, a sleeve, and a frame that functions with an empty beverage container to two configurations,
a first configuration being used for cooking in which the frame supports the tray and the beverage container, and the sleeve is positioned around the tray, the beverage container and the stand so that it functions as a windscreen and a heat reflector, and a second configuration in which the insulating band is positioned around the top opening of the beverage container, and the frame is wrapped around the beverage container, the tray and the sleeve, holding the beverage container, the tray and the sleeve together for storage.

15. An ultra-light, collapsible, soot-enclosing, windprotected insulated backpacking stove for heating fluids contained within a lightweight vessel, the stove comprising:
a light weight vessel serving as a fluid container a flexible and moveable sleeve serving as a windscreen during heating of the vessel, a thermal insulator during holding of the heated vessel and as a structural support of the vessel during transport, a collapsible heating tray serving as a holder of fuel and a thermal insulator during holding of the heated vessel, and
a lightweight and invertible frame serving as a support for the vessel above the tray during heating of the vessel and as a soot-encloser and a vessel mechanical support during transport.

16. A stove as in claim 15, wherein the sleeve is a self supporting flexible cylindrical wall having an expandable opening to provide access to the tray for air and ignition means in the first configuration and is stiffly clamped between the tray and the frame for rigidity in the second configuration.

17. A stove as in claim 15, wherein the collapsible tray comprises an upper component and a lower component that can be arranged in either a first configuration or a second configuration,
wherein the first configuration is an extended position that supports the vessel substantially above the tray while heating, and
wherein the second configuration is a collapsed and nested position that positions the tray adjacent to the bottom of the vessel for providing insulation while holding heated vessel and for enclosing soot during transport.

18. A stove as in claim 15, wherein the invertible frame comprises an upper component and a lower component that can be arranged in either a first configuration or a second configuration,
wherein the first configuration is an stacked position that supports the vessel substantially above the tray while heating, and
wherein the second configuration is an inverted and nested position that encloses the vessel within the tray and the frame for providing insulation while holding heated vessel and for enclosing soot during transport.

19. A stove as in claim 18, the tray and frame components are made from wire with internal diameters for providing support in the first configuration and nesting in the second configuration.

20. A method of stabilizing a cook pot, the method comprising
first grasping the cook pot with a vertical suspension means of a tray in compression and
in turn clamping the vertical suspension means of the tray into protuberances of a frame supporting the cook pot.

21. A method of configuring an apparatus comprising a cook pot, a tray, a sleeve and a frame into a cooking configuration, comprising the following steps:
placing the frame on a cooking surface,
placing the tray onto the top of the frame so its fuel platform is located below the top of the frame,
placing the cook pot on top of the frame, and
wrapping the sleeve around the frame, tray and cook pot so that it functions as a windscreen.

22. A method of configuring an apparatus comprising a cook pot, a tray, a sleeve and a frame into a storage configuration, comprising the following steps:
sliding the tray over the bottom of the cook pot so that the fuel platform of the tray abuts the bottom of the cook pot,
wrapping the sleeve around the tray and cook pot, and
sliding the large end of the frame over the sleeve, tray, and cook pot effectively securing all the parts together.
